(19) United States
(12) Patent Application Publication
(10) Pub. No.: US 2016/0114343 A1
(43) Pub. Date: Apr. 28, 2016

(54) Portable air supply

(71) Applicant: Mike Behnke, Frisco, TX (US)

(72) Inventor: Mike Behnke, Frisco, TX (US)

(21) Appl. No.: 14/523,907

(22) Filed: Oct. 26, 2014

(51) Int. Cl. B05B 9/01; B05B 9/08

(52) U.S. Cl. CPC B05B 9/01; B05B 9/0805

(57) ABSTRACT

A handheld airgun to provide a source of pressurized fluid may include a power housing to house a power supply, a motor housing to house a motor to connect to the power supply, a turbine compressor housing to house a turbine and a compressor to connect to the motor housing and to generate the pressurized fluid, a nozzle to distribute the pressurized fluid and a trigger to activate the flow of pressurized fluid.

### FIELD OF THE INVENTION

The present invention relates to a supply of fluid such as air and more particularly to a handheld air gun which may be in the shape of a pistol.

### BACKGROUND

Pressurized air or other types of fluid has many purposes. Pressurized air may be used for cleaning hard to reach areas from dust and other lightweight debris. There is a need for the source of pressurized air to be portable.

U.S. Pat. No. 6,752,335 discloses that blow-guns are commonly used to remove debris in a work environment, including for example in the engine compartment of a vehicle. When the area requiring the attention of a blow-gun is directly accessible, a standard linear barrel is generally sufficient. However, certain hard-to-reach or obstructed places may be shielded by the blast of air from the linear barrel of a standard blow-gun. Because areas of use vary greatly, it has been heretofore necessary to have multiple blow-guns of variously configured fixed barrels.

The use of two or more separate blow-guns requires disconnection of a pressurized air hose to the intake of one blow-gun and then subsequent reconnection of the pressurized air hose to the intake of a second blow-gun. This procedure is both time and labor-intensive and often requires a delay in work. Moreover, this procedure is largely unnecessary since the handle of a blow-gun serves the same function (i.e. receiving air from a pressurized air source via the air intake and then distributing the air to the barrel attachment) regardless of the barrel attached thereto.

This patent discloses a single blow-gun having a pivoting barrel capable of achieving non-linear configurations can respond to any number of different situations in a work environment, without the cost and inconvenience of maintaining a plurality of blow-guns having differently-configured fixed barrels. Similarly, this patent discloses that a blow-gun with a quick-connect attachment device can allow for the easy swapping of barrel attachments, such as pivoting, telescoping, swiveling, fixed length, etc., thus enabling the use of a single blow-gun with many attachments instead of multiple separate blow-gun units.

### SUMMARY

The handheld airgun/blowgun of the present invention is the may be a handheld electric compressed air gun or a handheld electric airgun which may be in the shape of a conventional drill. The handheld airgun may include a multitude of chambers or cavities in order to store the above described components. For example, the handheld airgun may include a power cavity to house the power supply which may be interchangeable and pluggable into the motor cavity to house the motor. The motor cavity may be connected to the turbine compressor cavity which may include the turbine and the compressor to generate compressed air for the storage tank. The turbine compressor cavity may be connected to the tank cavity which may house the storage tank and the valve.

A nozzle may be connected to the valve in order to direct the pressurized air (fluid).

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a circuit diagram of the handheld airgun of the present invention; and

FIG. 2 illustrates a side view of the handheld airgun of the present invention;

FIG. 3 illustrates a front view of the handheld airgun of the present invention.

### DETAILED DESCRIPTION

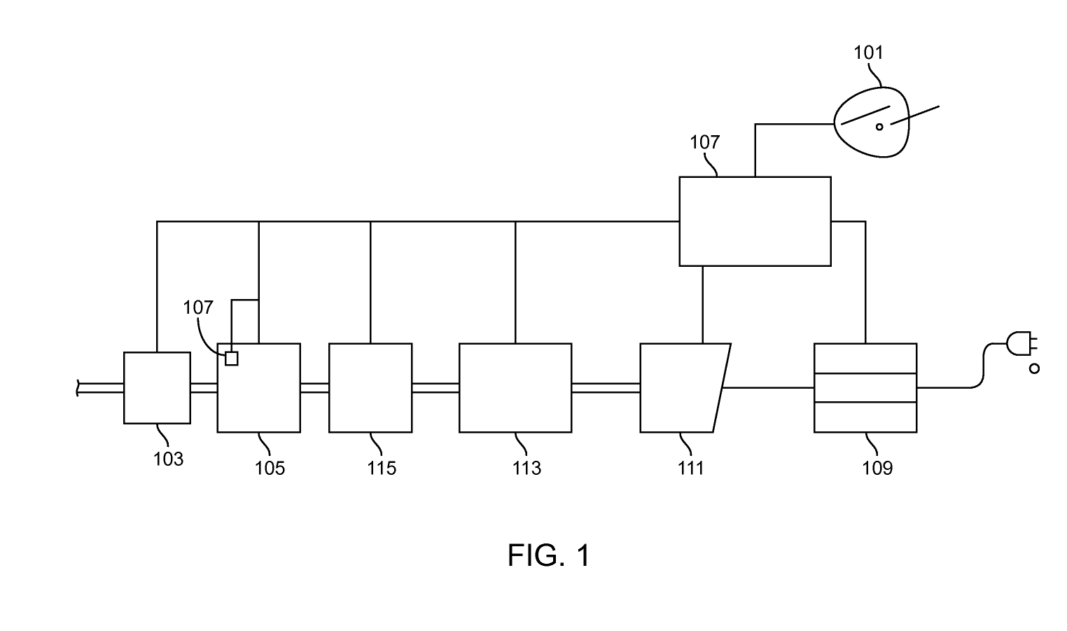

FIG. 1 illustrates a circuit diagram of the handheld airgun/blowgun 100 of the present invention, yet it should be understood that while the present invention is described in terms of air, other fluids and or combination of fluids may be appropriately used with the teachings of the present invention.

FIG. 1 illustrates a switch 101 which may be a trigger to activate the handheld airgun 100 to allow the valve 103 to open and allow the pressurized air (fluid) to flow from the handheld airgun 100 from the storage tank 105. The storage tank 105 may be in fluid communication with the valve 103 and may include a sensor 107 in order to sense the pressure within the storage tank 105. When the sensed pressure falls below a predetermined pressure, the controller 107 activates the power supply 109 and the motor 111 which may drive the turbine 113 to produce compressed air within the compressor 115 which is transmitted to the storage tank 105 where the pressurized air is stored.

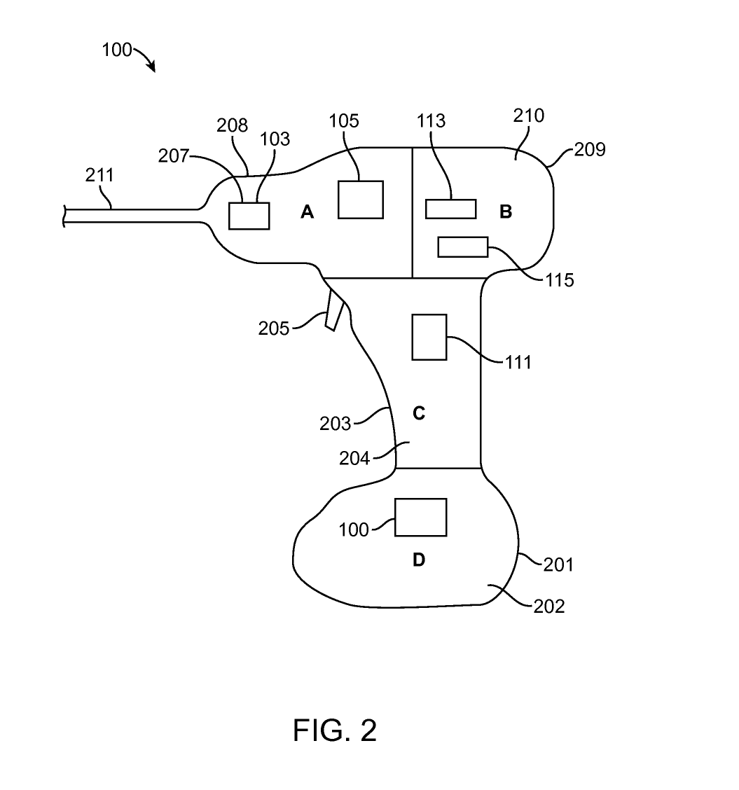

FIG. 2 illustrates the handheld airgun 100 of the present invention which may be a handheld electric compressed air gun or a handheld electric airgun which may be in the shape of a conventional drill. The handheld airgun 100 may include a multitude of housings including chambers or cavities in order to store the above described components. For example, the handheld airgun 100 may include a power housing 202 including a power cavity 201 to house the power supply 109 which may be interchangeable and pluggable into a motor housing 204 including the motor cavity 203 to house the motor 111. The motor cavity 203 may be connected to a turbine compressor housing 210 including the turbine compressor cavity 209 which may include the turbine 113 and the compressor 115 to generate compressed air for the storage tank 105. The motor housing 204 may be narrower than the turbine compressor housing 210 and the power housing 202. The motor housing 204 and may be used as a grip to activate the trigger 101. The turbine compressor cavity 209 may be connected to a tank housing 208 including the tank cavity 207 which may house the storage tank 205 and the valve 103.

FIG. 2 additionally illustrates a nozzle 211 which may be connected to the valve 103 in order to direct the pressurized air (fluid).

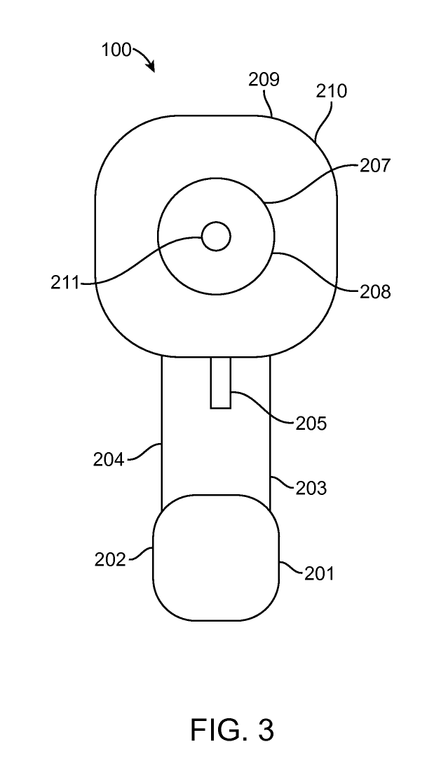

FIG. 3 illustrates the handheld airgun 100 of the present invention which may be a handheld electric compressed air gun or a handheld electric airgun which may be in the shape of a conventional handheld drill. The handheld airgun 100 may include a multitude of housing which may include chambers or cavities in order to store the above described components. For example, the handheld airgun 100 may include a power housing including a power cavity 201 to house the power supply 109 which may be interchangeable and pluggable into the motor housing including the motor cavity 203 to house the motor 111. The motor cavity 203 may be connected to the turbine compressor housing including the turbine compressor cavity 209 which may include the turbine 113 and the compressor 115 to generate compressed air for the storage tank 105. The turbine compressor cavity 209 may be connected to the tank cavity 207 which may house the storage tank 205 and the valve 103.

FIG. 3 additionally illustrates a nozzle 211 which may be connected to the valve 103 in order to direct the pressurized air (fluid).

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A handheld airgun to provide a source of pressurized fluid, comprising:
a power housing to house a power supply:
a motor housing to house a motor to connect to the power supply;
a turbine compressor housing to house a turbine and a compressor to connect to the motor housing and to generate the pressurized fluid;
a nozzle to distribute the pressurized fluid;
a trigger to activate the flow of pressurized fluid.

2) A handheld airgun to provide a source of pressurized fluid as in claim 1, wherein the power supply includes a battery.

3) A handheld airgun to provide a source of pressurized fluid as in claim 1, wherein the motor rotates the turbine.

4) A handheld airgun to provide a source of pressurized fluid as in claim 1, wherein the handheld airgun is in the shape of a drill device.

5) A handheld airgun to provide a source of pressurized fluid as in claim 1, wherein the tank cavity includes a valve to control the flow of pressurized fluid.

6) A handheld airgun to provide a source of pressurized fluid as in claim 1, wherein the pressurized fluid is pressurized air.
